(19) United States
(12) Patent Application Publication
(10) Pub. No.: US 2013/0314444 A1
(43) Pub. Date: Nov. 28, 2013

(54) IMAGE DATA TRANSMITTING DEVICE, IMAGE DATA RECEIVING DEVICE, IMAGE DATA TRANSMITTING SYSTEM, IMAGE DATA TRANSMITTING METHOD, IMAGE DATA RECEIVING METHOD, TRANSMISSION IMAGE DATA, AND COMPUTER PRODUCT

(71) Applicant: TAMRON CO., LTD., Saitama-shi (JP)

(72) Inventors: Toru IWAMOTO, Saitama-shi (JP); Yuji Honjo, Saitama-shi (JP); Keisuke Taguchi, Saitama-shi (JP)

(73) Assignee: TAMRON CO., LTD., Saitama-shi (JP)

(21) Appl. No.: 13/856,127

(22) Filed: Apr. 3, 2013

(30) Foreign Application Priority Data
May 22, 2012 (JP) 2012-116968

(51) Int. Cl. G06T 5/00

(52) U.S. Cl. CPC G06T 5/001
USPC 345/647

(57) ABSTRACT

An image data transmitting device inputs and outputs to an external device, fisheye image data that includes a fisheye image captured by a lens that causes distortion to occur in an image at a wide angle view. The image data transmitting device includes a distortion correction processing unit that corrects the distortion of the fisheye image and forms a distortion corrected image; and a transmission image data generating unit divides along a scanning line, the distortion corrected image into a plurality of lines, re-arranges the lines based on a given criterion, forms a converted image, inserts the converted imaged into an area in which no effective video signal of the fisheye image data is present, and generates transmission image data.

### BACKGROUND OF THE INVENTION

1. Field of the Invention

The present invention relates to an image data transmitting device, image data receiving device, image data transmitting system, image data transmitting method, image data receiving method, transmission image data, and computer product that digitize and transmit fisheye images and corrected images thereof.

2. Description of the Related Art

FIG. 16 is a diagram depicting one example of a fisheye image captured by a fisheye lens. Although a fisheye lens has a property of being able to capture, in one shot, an image covering a wide range, the image is subject to curved distortion. Thus, technology has been disclosed that corrects fisheye image distortion to form a more natural-looking image equivalent to that captured by a normal lens (see, for example, U.S. Pat. No. 5,359,363).

Nonetheless, conventionally when fisheye image distortion is corrected, only the distorted portion is isolated and corrected, not the entire image. FIG. 17 is a diagram depicting an example of an image that has been corrected for fisheye distortion. In comparing FIGS. 16 and 17, it becomes obvious that a portion of the image captured by the fisheye lens is missing from the distortion-corrected image. In other words, areas excluding the portion corrected for distortion become unseen areas and a primary feature of fisheye lenses (the capturing of wide angle views) is lost.

This short-coming is cancelled by viewing the fisheye image and the corrected image together. If more emphasis is placed on a clear image than on preventing the occurrence of unseen areas, comparison of the fisheye image and the corrected image has to be enabled. Typically, viewing is performed from a position away from the imaging apparatus that is equipped with the fisheye lens and consequently, the fisheye image and the corrected image have to be independently digitized and transmitted. As a result, problems arise in that compared to a handling of one type of image data, drops in image data transfer rates consequent to increased processing may occur and efficient image data transmission becomes difficult.

### SUMMARY OF THE INVENTION

It is an object of the present invention to at least solve the above problems in the conventional technologies.

An image data transmitting device according to one aspect of the present invention inputs and outputs to an external device, fisheye image data that includes a fisheye image captured by a lens that causes distortion to occur in an image at a wide angle view. The image data transmitting device includes a distortion correction processing unit that corrects the distortion of the fisheye image and forms a distortion corrected image; and a transmission image data generating unit divides along a scanning line, the distortion corrected image into a plurality of lines, re-arranges the lines based on a given criterion, forms a converted image, inserts the converted imaged into an area in which no effective video signal of the fisheye image data is present, and generates transmission image data.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram depicting an image data transmitting system according to a first embodiment;

FIG. 2 is a schematic depicting an example of fisheye image data 200 generated by a camera 110;

FIG. 3 is a diagram depicting an example of a distortion corrected image 300 resulting from correction by a distortion correction processing unit 122;

FIG. 4 is a diagram for describing a conversion process of a distortion corrected image 300 performed by a transmission image data generating unit 123;

FIG. 5 is a diagram depicting an example of transmission image data 500 generated by the transmission image data generating unit 123;

FIG. 6 is a block diagram of one example of a hardware configuration of an image data transmitting device 120 and an image data receiving device 130;

FIG. 7 is a flowchart of a generation process of the transmission image data 500;

FIG. 8 is a flowchart of a restoration process of a converted image 400;

FIG. 9 is a flowchart of an image display control process;

FIG. 10 is a diagram for describing a conversion process of the distortion corrected image 300 performed by the transmission image data generating unit 123;

FIG. 11 is a diagram depicting an example of transmission image data 1100 generated by the transmission image data generating unit 123;

FIG. 12 is a diagram for describing the conversion process of the distortion corrected image 300 performed by the transmission image data generating unit 123;

FIG. 13 is a diagram depicting an example of transmission image data 1300 generated by the transmission image data generating unit 123;

FIG. 14 is a diagram for describing the conversion process of the distortion corrected image 300 performed by the transmission image data generating unit 123;

FIG. 15 is a diagram depicting an example of transmission image data 1500 generated by the transmission image data generating unit 123;

FIG. 16 is a diagram depicting one example of a fisheye image captured by a fisheye lens; and

FIG. 17 is a diagram depicting an example of an image that has been corrected for fisheye distortion.

### DETAILED DESCRIPTION OF THE PREFERRED EMBODIMENTS

With reference to the accompanying drawings, preferred embodiments of an image data transmitting device, image data receiving device, image data transmitting system, transmission image data,image data transmitting method, image data receiving method, transmission image data, and program according to the present invention will be described.

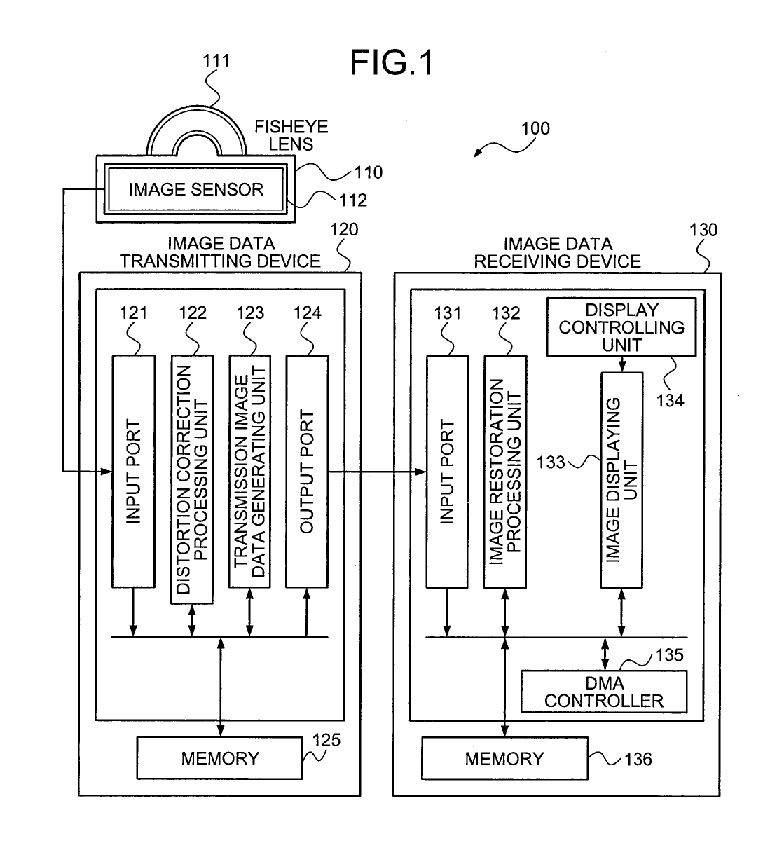

FIG. 1 is a diagram depicting an image data transmitting system according to a first embodiment. An image data transmitting system 100 includes a camera 110, an image data transmitting device 120, and an image data receiving device 130. The camera 110 and the image data transmitting device 120 may be connected directly or through a communication line. Further, the camera 110 and the image receiving device 130 may be integrated. The image data transmitting device 120 and the image data receiving device 130 may be connected directly or through a communication line.

The camera 110 includes a fisheye lens 111 and an image sensor 112. The camera 110 has a function of converting light that is from an object and collected by the fisheye lens 111 into an electrical signal via the image sensor 112 and after further converting the electrical signal into a digital signal, the camera 110 performs various types of signal processing to generate fisheye image data. The fisheye image data is sent to the image data transmitting device 120.

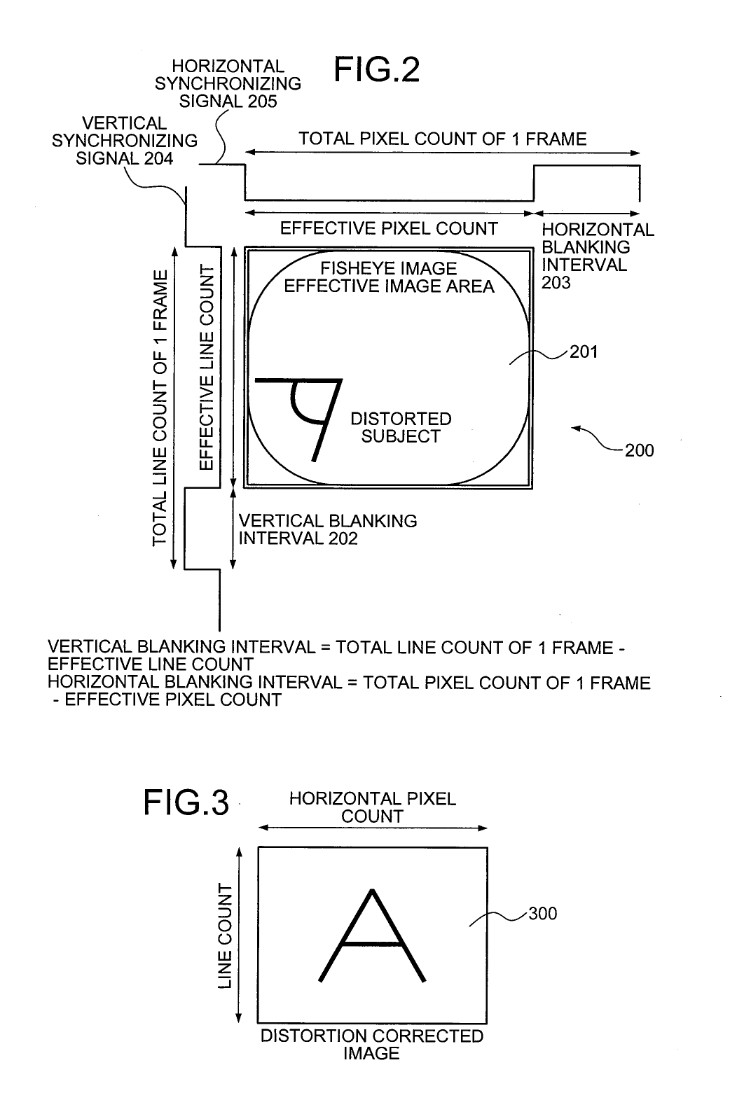

FIG. 2 is a schematic depicting an example of fisheye image data 200 generated by the camera 110. In the figure, the data of one frame is depicted. The fisheye image data 200 includes a fisheye image 201 to which a vertical blanking interval 202 and a horizontal blanking interval 203 are imparted. One cycle of a vertical synchronizing signal 204 includes the image data of one frame; and one cycle of a horizontal synchronizing signal 205 includes the image data of one line. In general, to display an image on a displaying unit, the image is drawn line by line from the upper left corner of the screen to the lower right of the screen. The horizontal blanking interval 203 is an interval from the end of the display of one line until the start of the display of the subsequent line. On the other hand, the vertical blanking interval 202 is an interval from the end of the drawing of line lowest on the screen until the start of the drawing of line highest on the screen.

Thus, an image corresponding to one frame is formed by displaying an image of all the lines. Further, since no effective video signal is present in the horizontal blanking interval 203 or the vertical blanking interval 202, no image is displayed. The vertical blanking interval 202 corresponds to the difference of the total line count of one image frame less the effective line count. Further, the horizontal blanking interval 203 corresponds to the difference of the total pixel count for one frame less the effective pixel count.

Again with reference to FIG. 1, a functional configuration of the image data transmitting device 120 will be described. The image data transmitting device 120 includes an input port 121, the distortion correction processing unit 122, a transmission image data generating unit 123, an output port 124, and memory 125.

The input port 121 inputs the fisheye image data 200 output from the camera 110. The distortion correction processing unit 122 corrects the distortion of the fisheye image 201 extracted from the fisheye image data 200 input via the input port 121, and forms a natural-looking image equivalent to that captured by a normal lens. For example, to convert the fisheye image 201 into a two-dimensional, planar image for display, after RGB color conversion of the fisheye image 201, general distortion correction processing is performed and the fisheye image 201 is converted into a planar image. FIG. 3 is a diagram depicting an example of a distortion corrected image 300 resulting from correction by the distortion correction processing unit 122.

The transmission image data generating unit 123 divides the distortion corrected image 300 formed by the distortion correction processing unit 122 into multiple lines along a scanning line, and based on a given criterion, changes the order of the lines to form a converted image. The transmission image data generating unit 123 inserts the converted image into an area in which no effective video signal of the fisheye image data 200 input via the input port 121 is present.

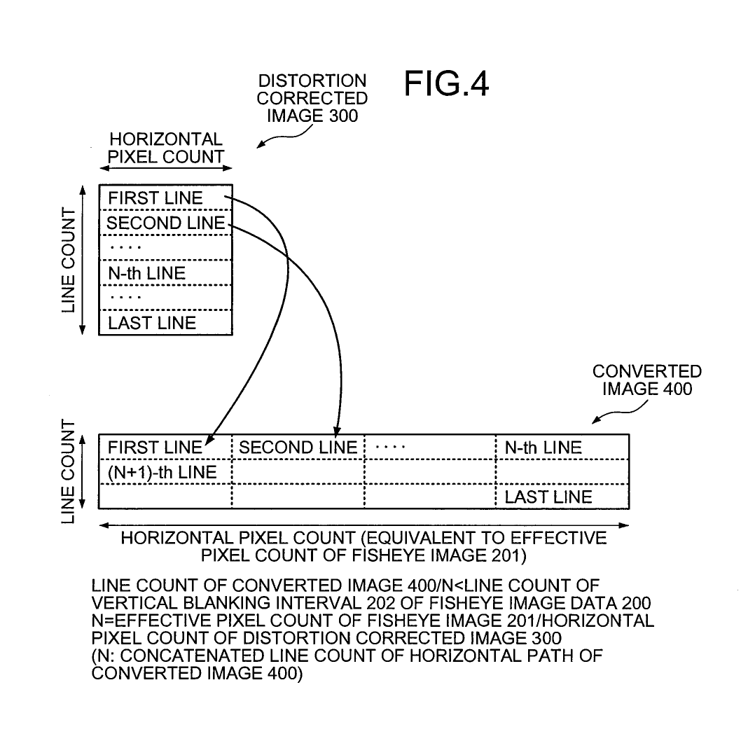

FIG. 4 is a diagram for describing a conversion process of the distortion corrected image 300 performed by the transmission image data generating unit 123. As depicted in FIG. 4, the transmission image data generating unit 123 divides the distortion corrected image 300 according to line, along the scanning line. Next, the transmission image data generating unit 123, sequentially from the first line, concatenates the lines in a single direction of the lines, such that the horizontal path is within the sum of the effective pixel count of the fisheye image 201 and the pixel count of the horizontal blanking interval, and the vertical path is within the line count of the vertical blanking interval of the fisheye image data 200. Alternatively, the transmission image data generating unit 123, sequentially from the first line, concatenates the lines in a left-to-right direction of the lines, such that the horizontal path becomes equivalent to the effective pixel count of the fisheye image 201, and the vertical path is within the line count of the vertical blanking interval 202 of the fisheye image data 200. Thus, a converted image 400 of a size that can be accommodated within the capacity of the vertical blanking interval 202 is formed.

The converted image 400 depicted in FIG. 4 represents an example where in the first row, the first line to an N-th line (where, N is a natural number) are arranged, and in the second row and thereafter, an (N+1)-th line to the last line are arranged.

In other words, in the present embodiment, when the concatenated line count of the horizontal path of the converted image 400 is N, the converted image 400 is formed maintaining the following relations among the fisheye image data 200, the fisheye image 201, the distortion corrected image 300, and the converted image 400.
line count of converted image 400/N<line count of vertical blanking interval 202 of fisheye image data 200
N=effective pixel count of fisheye image 201/horizontal pixel count of distortion corrected image 300

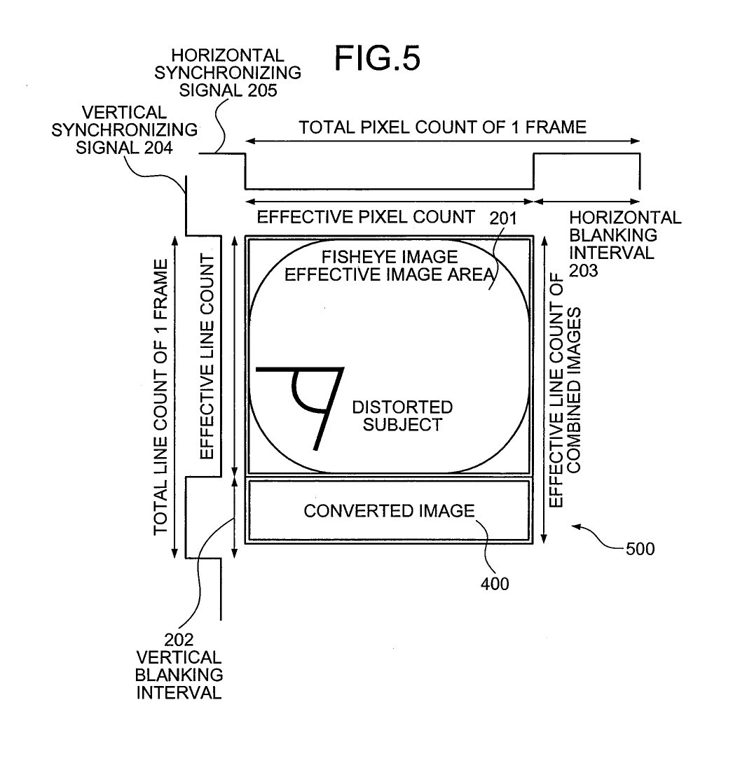

FIG. 5 is a diagram depicting an example of transmission image data 500 generated by the transmission image data generating unit 123. By inserting the converted image 400 into the vertical blanking interval 202, which is an area in which no effective video signal of the fisheye image data 200 is present, the transmission image data generating unit 123 combines the converted image 400 and the fisheye image 201, and generates the transmission image data 500. The transmission image data 500 is transmitted from the output port 124 to an external device. The converted image 400 is of a size that can be accommodated within the capacity of the vertical blanking interval 202 and consequently, even if the transmission image data 500 includes the fisheye image 201 together with the converted image 400, the data volume does not become large.

The memory 125 stores the input fisheye image data 200, the distortion corrected image 300, the converted image 400, the transmission image data 500, and the like. The memory 125 has a further function as a work area of the distortion correction processing unit 122 and the transmission image data generating unit 123.

As described, the image data transmitting device 120 divides and re-arranges the distortion corrected image 300 of the fisheye image 201 to form the converted image 400 that can be easily inserted into the vertical blanking interval 202, an area in which no effective video signal of the fisheye image data 200 is present. The image data transmitting device 120 inserts the converted image 400 into the vertical blanking interval 202 of the fisheye image data 200 to generate the transmission image data 500 and by transmitting the transmission image data 500, two types of images can be transmitted by a single transmission of image data. As a result, multiple images can be transmitted without drops in the data transfer rate and efficient image transmission can be facilitated. Furthermore, since the converted image 400 can be formed by a simple process, complicated image processing is unnecessary, enabling a simple device configuration to be realized.

With reference to FIG. 1, a functional configuration of the image data receiving device 130 will be further described. The image data receiving device 130 includes an input port 131, an image restoration processing unit 132, an image displaying unit 133, a display controlling unit 134, a DMA controller 135, and memory 136.

The input port 131 inputs the transmission image data 500 output from the image data transmitting device 120. The image restoration processing unit 132 extracts the converted image 400 from the transmission image data 500 input via the input port 131 and restores the converted image 400. Here, the distortion corrected image 300 is formed by following the generation process of the converted image 400 in reverse order. The image restoration processing unit 132 divides the converted image 400 into respective lines arranged based on a given criterion and re-arranges the lines into the line sequence. For example, the image restoration processing unit 132 divides according to line, the converted image 400 in which each of the lines of the distortion corrected image 300 are concatenated continuously from left to right, and by arranging the resulting lines sequentially from the first line and in a direction orthogonal to the scanning line used as a reference for dividing the converted image 400, the image restoration processing unit 132 places each line at its original position before the division and can restore the distortion corrected image 300.

The image displaying unit 133 displays the fisheye image 201 included in the transmission image data 500 and/or the distortion corrected image 300 restored by the image restoration processing unit 132. Switching between these image displays is performed by the display controlling unit 134.

The DMA controller 135 successively stores to the memory 136, data output to an external bus. The DMA controller 135 further transfers data stored in the memory 136 to other hardware modules. The memory 136 stores the input transmission image data 500, the distortion corrected image 300, the converted image 400 and the like. The memory 136 has a further function as a work area of the image restoration processing unit 132.

As described, the image data receiving device 130 extracts only the converted image 400 from the transmission image data 500, which includes the fisheye image 201 and the converted image 400 of the distortion corrected image 300, and can easily restore the converted image 400 into the distortion corrected image 300. Since the converted image 400 is formed by a simple process, the restoration process is simple. Further, not just the restored distortion corrected image 300, but also comparison with the fisheye image 201 can be viewed easily, enabling the loss of a primary feature of fisheye lenses to be prevented. Although the distortion corrected image 300 is temporarily converted into the converted image 400, an image identical to the distortion corrected image 300 before conversion is obtained by restoration. Accordingly, drops in the frame rate do not occur, even with the converted image 400 as an intermediate form.

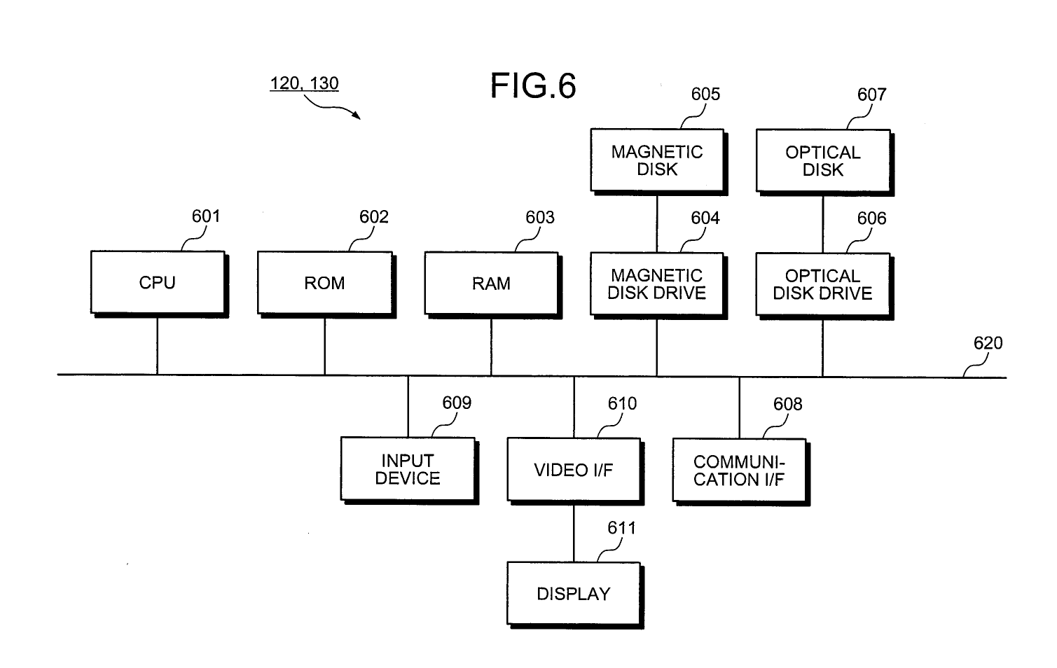

A hardware configuration of the image data transmitting device 120 and the image data receiving device 130 in the image data transmitting system 100 according to the first embodiment will be described. FIG. 6 is a block diagram of one example of a hardware configuration of the image data transmitting device 120 and the image data receiving device 130. In FIG. 6, the image data transmitting device 120 (the image data receiving device 130) includes a CPU 601, ROM 602, RAM 603, a magnetic disk drive 604, a magnetic disk 605, an optical disk drive 606, an optical disk 607, a communication interface (I/F) 608, an input device 609, a video I/F 610, and a display 611, respectively connected by a bus 620.

The CPU 601 governs overall control of the image data transmitting device 120 or the image data receiving device 130. The ROM 602 stores various types of programs such as a boot program, a communication program, an image display program, and for the image data transmitting device 120: a distortion correction program and an image data generation program, and for the image data receiving device 130: an image restoration program, etc.

The RAM 603, for example, is used as a work area of the CPU 601. The magnetic disk drive 604, under the control of the CPU 601, controls the reading and writing of data with respect to the magnetic disk 605. The magnetic disk 605 stores data written thereto under the control of the magnetic disk drive 604. A hard disk (HD), flexible disk (FD), and the like can be used as the magnetic disk 605.

The optical disk drive 606, under the control of the CPU 601, controls the reading and writing of data with respect to the optical disk 607. The optical disk 607 is a removable recording medium from which data is read under the control of the optical disk drive 606. A writable recording medium can be used as the optical disk 607. Further, in addition to the optical disk 607, an MO, a memory card, and the like can be used as a removable recording medium.

The communication I/F 608 functions as an interface between the CPU 601 and, the image data transmitting device 120 or the image data receiving device 130. The communication I/F 608 is connected through a network or is connected directly to an external device and further functions as an interface between the external device and the CPU 601. The network may include a local area network (LAN), a wide area network (WAN), a public line network, a mobile telephone network, and the like.

The input device 609 may be a remote controller or a keyboard having keys for inputting text, numeric values and various types of instructions; a mouse; a touch panel; etc.

The video I/F 610 is connected to the display 611. The video I/F 610 is made up of, for example, a graphic controller that controls the display 611, a buffer memory such as VRAM (Video RAM) that temporarily stores immediately displayable image information, and a control IC that controls the display 313 based on image data output from the graphic controller.

The display 611 displays icons, a cursor, menus, windows, or various data such as text and images. A CRT, a TFT liquid crystal display, a plasma display, and the like may be employed as the display 611.

In the image data transmitting device 120, functions of the input port 121 and the output port 124 can be implemented by the CPU 601 executing a communication program and controlling the communication I/F 608. A function of the distortion correction processing unit 122 can be implemented by the CPU 601 executing a distortion correction program. A function of the transmission image data generating unit 123 can be implemented by the CPU 601 executing an image data generation program. A function of the memory 125 can be implemented by the RAM 603.

In the image data receiving device 130, a function of the input port 131 can be implemented by the CPU 601 executing a communication program and controlling the communication I/F 608. A function of the image restoration processing unit 132 can be implemented by the CPU 601 executing an image restoration program. A function of the image displaying unit 133 can be implemented by the display 611. A function of the display controlling unit 134 can be implemented by the CPU 601 executing an image display program and controlling the video I/F 610. The DMA controller 135 is integrated into the CPU 601. A function of the memory 136 can be implemented by the RAM 603.

Processes of the image data transmitting system according to the first embodiment will be described. Hereinafter, a transmission image data generation process, a converted image restoration process, and an image display control process will be described independently.

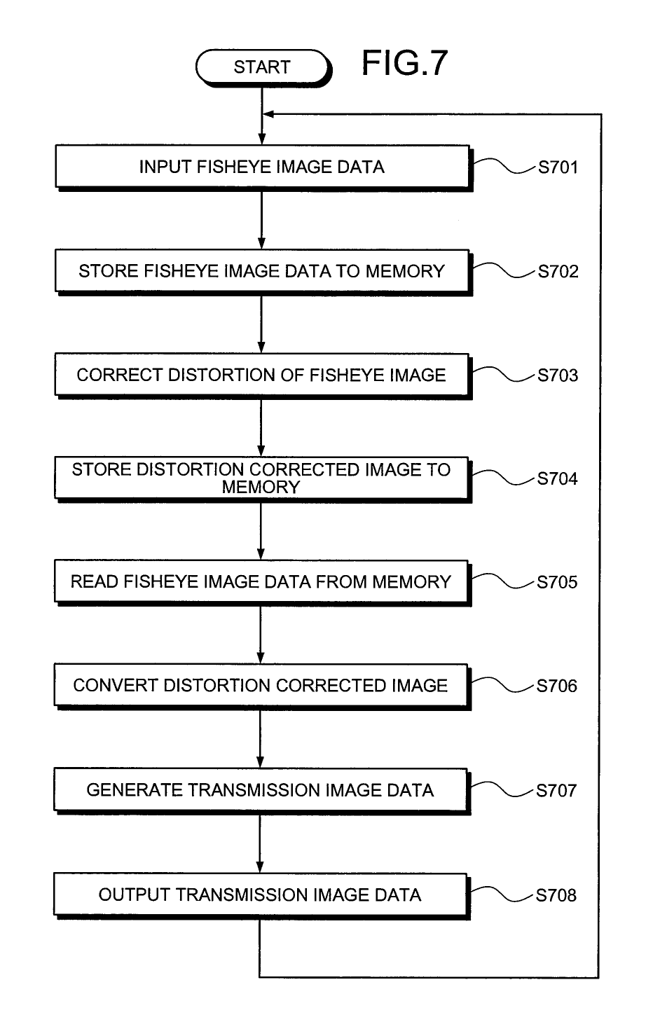

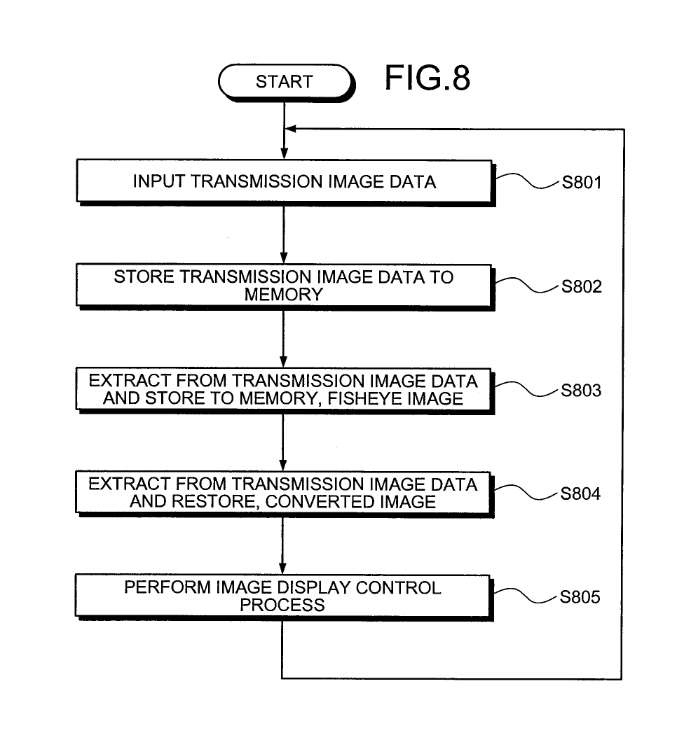

The transmission image data generation process for the transmission image data 500 will be described. This process is executed by the image data transmitting device 120. FIG. 7 is a flowchart of the generation process of the transmission image data 500.

In the flowchart depicted in FIG. 7, the image data transmitting device 120 inputs fisheye image data (step S701). The input port 121 inputs the fisheye image data 200 (refer to FIG. 2) that is of one frame and output from the camera 110.

The image data transmitting device 120 stores the fisheye image data to memory (step S702). Here, the distortion correction processing unit 122 stores the fisheye image data 200 to the memory 125.

The image data transmitting device 120 corrects distortion of the fisheye image (step S703). For example, to convert the fisheye image 201 into two-dimensional, planar image for display, the distortion correction processing unit 122 after RGB color converting the fisheye image 201, performs distortion correction processing, and converts the fisheye image 201 into a planar image. Thus, distortion of the fisheye image 201 is corrected and the fisheye image 201 becomes a natural-looking image equivalent to that captured by a normal lens (refer to FIG. 3).

The image data transmitting device 120 stores the distortion corrected image to the memory (step S704). Here, the distortion correction processing unit 122 stores to the memory 125, the distortion corrected image 300 of the fisheye image 201, formed at step S703.

The image data transmitting device 120 reads the fisheye image data from the memory (step S705). Here, the transmission image data generating unit 123 reads the fisheye image data 200 stored to the memory 125 at step S702.

The image data transmitting device 120 converts the distortion corrected image (step S706). Here, the transmission image data generating unit 123 reads the distortion corrected image 300 stored to the memory 125 at step S704 and divides the distortion corrected image 300 according to line, along the scanning line. The transmission image data generating unit 123, sequentially from the first line, arranges the lines in a single direction of the lines, such that the horizontal path is within the sum of the effective pixel count of the fisheye image 201 and the pixel count of the horizontal blanking interval, and the vertical path is within the line count of the vertical blanking interval of the fisheye image data 200. Alternatively, the transmission image data generating unit 123, sequentially from the first line, arranges the lines in a left-to-right direction, such that the horizontal path becomes equivalent to the effective pixel count of the fisheye image 201, and the vertical path is within the line count of the vertical blanking interval 202 of the fisheye image data 200. Thus, a converted image 400 of a size that can be accommodated within the capacity of the vertical blanking interval 202 is formed (refer to FIG. 4).

The image data transmitting device 120 generates transmission image data (step S707). Here, the transmission image data generating unit 123 inserts the converted image 400 formed at step S706, into the vertical blanking interval 202 of the fisheye image data 200 read from the memory 125 at step 5705 and generates the transmission image data 500 (refer to FIG. 5).

Lastly, the image data transmitting device 120 outputs the transmission image data (step S708). Here, the output port 124 transmits to an external destination, the transmission image data 500 generated at step S707. Thereafter, the image data transmitting device 120 returns to step S701 and performs the process with respect to the fisheye image data 200 of the subsequent frame.

Through steps such as those above, the converted image 400 in which the distortion corrected image 300 of the fisheye image 201 is divided and re-arranged can be inserted into the vertical blanking interval 202 in which no effective video signal of the fisheye image data 200 is present, and the transmission image data 500 can be generated. Thus, two types of images can be transmitted by a single transmission of image data and since multiple images can be transmitted without drops in the data transfer rate, efficient image transmission can be facilitated. Furthermore, since the converted image 400 can be formed by a simple process, complicated image processing is unnecessary, enabling a simple device configuration to be realized.

A restoration process of the converted image 400 will be described. This process is executed by the image data receiving device 130. FIG. 8 is a flowchart of the restoration process of the converted image 400.

In the flowchart depicted in FIG. 8, the image data receiving device 130 inputs transmission image data (step S801). The input port 131 inputs the transmission image data 500 (refer to FIG. 5) that is of one frame and output from the image data transmitting device 120.

The image data receiving device 130 stores the transmission image data to memory (step S802). Here, the image restoration processing unit 132 stores the transmission image data 500 to the memory 136.

The image data receiving device 130 extracts from the transmission image data and stores to the memory, a fisheye image (step S803). For example, the image restoration processing unit 132 reads the transmission image data 500 stored at step S802, extracts the fisheye image 201 included in the transmission image data 500, and stores the fisheye image 201 to the memory 136.

The image data receiving device 130 restores a converted image (step S804). The image restoration processing unit 132 reads the transmission image data 500 stored at step S802, extracts the converted image 400 included in the transmission image data 500, and restores the converted image 400. Here, the image restoration processing unit 132 divides according to line, the converted image 400 in which each of the lines of the distortion corrected image 300 are arranged continuously from left to right, and by arranging the resulting lines sequentially from the first line and in a direction orthogonal to the scanning line used as a reference for the first division of the converted image 400, the image restoration processing unit 132 places each line at its original position before the division and can restore the distortion corrected image 300.

The image data receiving device 130 performs the image display control process (step S805). This process is executed by the display controlling unit 134. Thereafter, the image data receiving device 130 returns to step S801 and performs the process with respect to the transmission image data 500 of the subsequent frame.

Through steps such as those above, from the transmission image data 500 that includes the fisheye image 201 and the converted image 400 of the distortion corrected image 300 of the fisheye image 201, the converted image 400 can be extracted, and the distortion corrected image 300 can be restored easily and displayed. Since the converted image 400 is formed by a simple process, the restoration process is simple.

The image display control process at step S805 will be described. The image data receiving device 130 can acquire the fisheye image 201 and the distortion corrected image 300 thereof and as a result, consequent to an arbitrary user operation of the image data receiving device 130, can enable viewing of the fisheye image 201 and/or the distortion corrected image 300. If the type of image required is known in advance, configuration is such that a request consequent to a user operation, from the image data receiving device 130 to the image data transmitting device 120, and for the type of image preliminarily determined to be viewed, is enabled. Thus, burden on the user can be reduced.

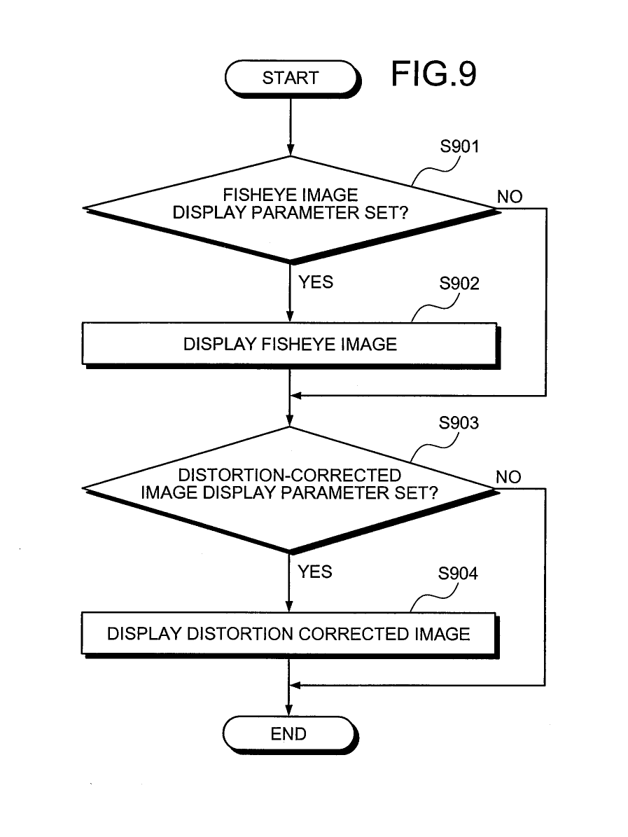

For example, a request is made from the image data receiving device 130 to the image data transmitting device 120 and indicates that the fisheye image 201 and/or the distortion corrected image 300 is to be viewed. At the image data receiving device 130, depending on the request, for example, given parameters are set. The parameter setting, for example, is performed at step S707 of the flowchart depicted in FIG. 7. Hereinafter, processing will be described under the assumption that parameter setting is performed. The following process is executed by the display controlling unit 134 of the image data receiving device 130. FIG. 9 is a flowchart of the image display control process.

In the flowchart depicted in FIG. 9, the display controlling unit 134 determines whether a fisheye image display parameter has been set (step S901). Here, the display controlling unit 134 reads the fisheye image 201 stored to the memory 136 at step S803, and determines whether a display parameter is set. If a display parameter is set (step S901: YES), the display controlling unit 134 displays the fisheye image 201 on the image displaying unit 133 (step S902), and proceeds to step S903. If no display parameter is set (step S901: NO), the display controlling unit 134 proceeds to step S903 without displaying the fisheye image 201 on the image displaying unit 133.

The display controlling unit 134 determines whether a distortion-corrected image display parameter has been set (step S903). Here, the display controlling unit 134 determines whether a display parameter is set for the distortion corrected image 300 restored at step S804. If a distortion-corrected image display parameter is set (step S903: YES), the display controlling unit 134 displays the distortion corrected image 300 on the image displaying unit 133 (step S904), and ends the process. If no distortion-corrected image display parameter is set (step S903: NO), the display controlling unit 134 ends the process without displaying the distortion corrected image 300 on the image displaying unit 133.

Through steps such as those above, an image of the type desired by the user is displayed. Not only the restored distortion corrected image 300, but also comparison with the fisheye image 201 can be easily viewed and the loss of a primary feature of fisheye lenses can be prevented. Although the distortion corrected image 300 is temporarily converted into the converted image 400, an image substantially identical to the distortion corrected image 300 before conversion is obtained by restoration. Accordingly, drops in the frame rate do not occur, even with the converted image 400 as an intermediate form. Further, by the user again performing an operation of the image data receiving device 130, the display of an image of a type different from the set parameter can be performed.

As described, the image data transmitting system of the first embodiment can insert into the vertical blanking interval 202 in which no effective video signal of the fisheye image data 200 is present, the converted image 400 formed by dividing and re-arranging the distortion corrected image 300 of the fisheye image 201 and generate the transmission image data 500. Two types of images can be transmitted by a single transmission of image data and thus, multiple images can be transmitted without drops in the data transfer rate, enabling efficient image transmission to be facilitated. Furthermore, since the converted image 400 can be formed by a simple process, complicated image processing is unnecessary, enabling a simple device configuration to be realized.

Since the converted image 400 is obtained by dividing and re-arranging the distortion corrected image 300 of the fisheye image 201, restoration can be performed easily. Further, not only the distortion corrected image 300, but also the viewing a comparison with the fisheye image 201 becomes easy and the loss of a primary feature of fisheye lenses can be prevented. Although the distortion corrected image 300 is temporarily converted into the converted image 400, an image identical to the distortion corrected image 300 before conversion is obtained by restoration. Accordingly, drops in the frame rate do not occur, even with the converted image 400 as an intermediate form. The data communicated between components of the image data transmitting system of the present embodiment can be compressed.

A second embodiment of the present invention will be described. The embodiment represents an example in which a converted image of the distortion corrected image 300 is inserted into in the horizontal blanking interval 203 of the fisheye image data 200. The overall configuration of the system is identical to that of the first embodiment. Hereinafter, only processes differing from the first embodiment will be described.

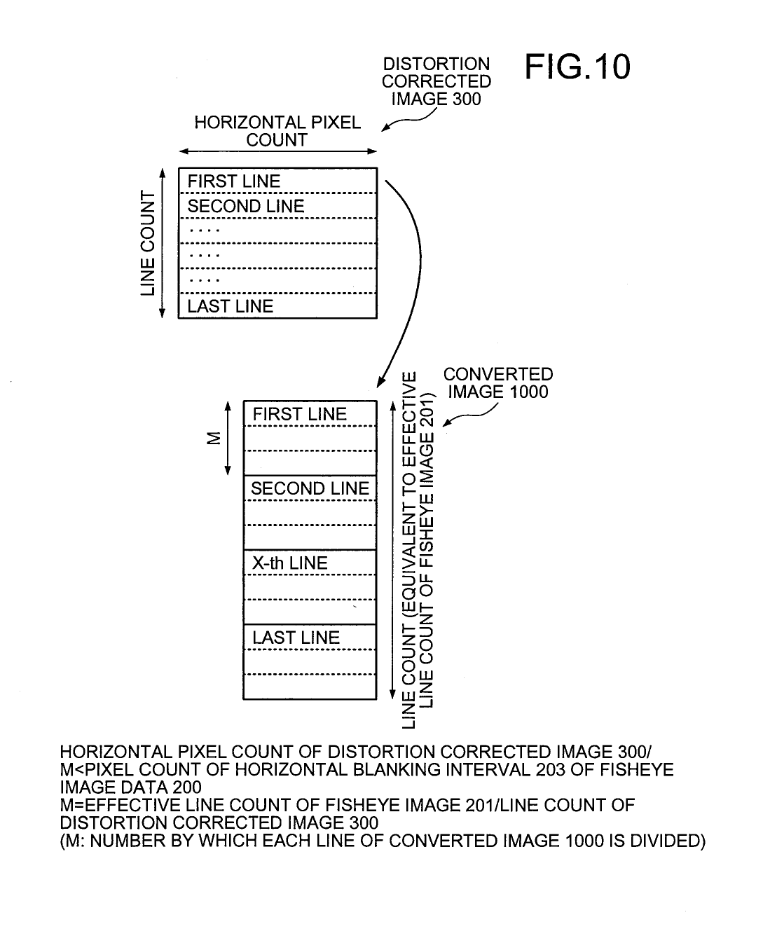

Processing by the image data transmitting device 120 will be described. FIG. 10 is a diagram for describing the conversion process of the distortion corrected image 300 performed by the transmission image data generating unit 123.

As depicted in FIG. 10, the transmission image data generating unit 123 divides the distortion corrected image 300 of one frame, according to line, along the scanning line (first division). The transmission image data generating unit 123 further divides the lines obtained from the first division into segments of a length that is within the pixel count of the horizontal blanking interval 203 of the fisheye image data 200 (second division). The transmission image data generating unit 123, sequentially from the first line and progressing downward, arranges the segments obtained from the second division, to be within the sum of the effective line count of the fisheye image 201 and the line count of the vertical blanking interval. Alternatively, the transmission image data generating unit 123, from the first line downward, arranges the segments obtained by the second division, to be within the effective line count of the fisheye image 201. Thus, a converted image 1000 of a size that can be accommodated within the capacity of the horizontal blanking interval 203 is formed.

In the converted image 1000 depicted in FIG. 10, the first line that has been divided into M segments (where, M is a natural number) is positioned at the uppermost position, followed sequentially by the second line that has been divided into M segments, the third line that has been divided into M segments, . . . , and the last line that has been divided into M segments. The line count of the converted image 1000 (the vertical path length) is equivalent to the effective line count of the fisheye image 201. The above process corresponds to step S706 of the flowchart depicted in FIG. 7.

In the present embodiment, when the number of segments into which the converted image 1000 is divided is M, the converted image 1000 is formed maintaining the following relations among the fisheye image data 200, the fisheye image 201, and the distortion corrected image 300.
horizontal pixel count of distortion corrected image 300/M<pixel count of horizontal blanking interval 203 of fisheye image data 200
M=effective line count of fisheye image 201/line count of distortion corrected image 300

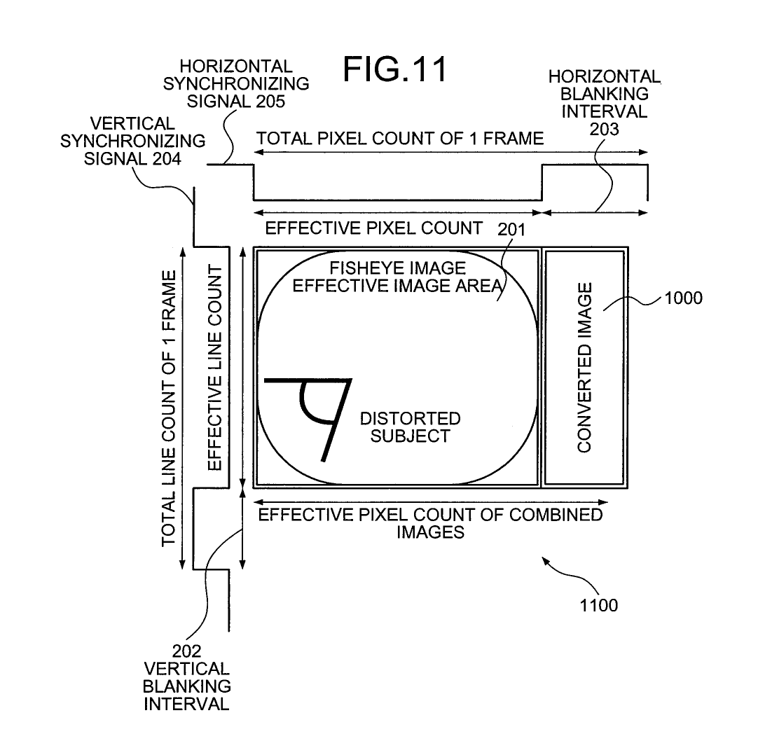

FIG. 11 is a diagram depicting an example of transmission image data 1100 generated by the transmission image data generating unit 123. The transmission image data generating unit 123 inserts the converted image 1000 into the horizontal blanking interval 203, which is an area in which no effective video signal of the fisheye image data 200 is present, and generates the transmission image data 1100. The converted image 1000 is of a size that can be accommodated with the capacity of the horizontal blanking interval 203 and consequently, even if the transmission image data 1100 accommodates the fisheye image 201 together with the converted image 1000, the data volume does not become large. The process above corresponds to step S707 in the flowchart depicted in FIG. 7.

Processing of the image data receiving device 130 will be described. The image restoration processing unit 132 extracts the converted image 1000 from the transmission image data 1100 input via the input port 131 and restores the converted image 1000.

Here, the distortion corrected image 300 is formed by following the generation process of the converted image 1000 in reverse order. The image restoration processing unit 132 separates the lines that are connected in the converted image 1000. Here, each line is returned to the state consequent to the second division, i.e., the lines are separated from each other, but are respectively in a state of being divided into M segments. Subsequently, the lines, which are respectively divided into M segments, are returned to the state after the first division, i.e., the segments are concatenated according to line, whereby each line occupies a single row. Finally, by arranging the lines in a direction orthogonal to the scanning line used as a reference when the lines are sequentially divided, each of the lines is returned to its original position, enabling the distortion corrected image 300 to be restored. The above process corresponds to step S804 in the flowchart depicted in FIG. 8.

As described, the image data transmitting system of the second embodiment can also achieve effects identical to those of the first embodiment by inserting into the horizontal blanking interval 203, which is an area in which no effective video signal of the fisheye image data 200 is present, the converted image 1000 obtained by dividing and re-arranging the distortion corrected image 300 of the fisheye image 201 and by transmitting the resulting fisheye image data 200.

A third embodiment of the present invention will be described. The embodiment is an example in which the distortion corrected image 300 is converted and inserted into the vertical blanking interval 202 and the horizontal blanking interval 203 of the fisheye image data 200. The technique of the embodiment is effective when the volume of the converted image cannot be accommodated by the vertical blanking interval 202 alone. The overall configuration of the system is identical to that of the first embodiment. Hereinafter, only processes differing from the previous embodiments above will be described.

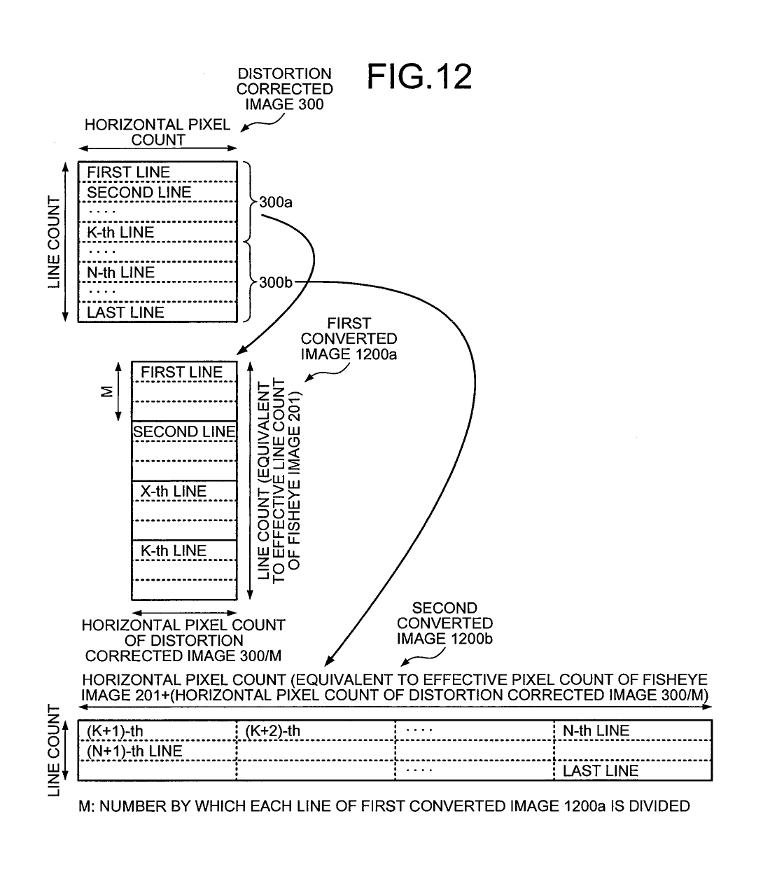

Processing of the image data transmitting device 120 will be described. FIG. 12 is a diagram for describing the conversion process of the distortion corrected image 300 performed by the transmission image data generating unit 123.

As depicted in FIG. 12, the transmission image data generating unit 123 divides the distortion corrected image 300 of one frame, according to line, along the scanning line (first division). The transmission image data generating unit 123 further divides a portion 300a of the lines resulting from the first division into segments of a length that is within the pixel count of the horizontal blanking interval 203 of the fisheye image data 200 (second division). The transmission image data generating unit 123, sequentially from the first line and progressing in a downward direction, arranges the lines subject to the second division, to be within the effective line count of the fisheye image 201. Thus, a first converted image 1200a of a size that can be accommodated within the capacity of the horizontal blanking interval 203 is formed.

In the first converted image 1200a depicted in FIG. 12, similar to the second embodiment, the first line that has been divided into M segments (where, M is a natural number) is positioned at the uppermost position, followed sequentially by the second line, the third line, . . . , and a K-th line (where, K is a natural number), each respectively divided into M segments. The horizontal pixel count (the horizontal path length) of the first converted image 1200a is equivalent to the horizontal pixel count of the distortion corrected image 300/M. The line count (the vertical path length) of the first converted image 1200a is equivalent to the effective line count of the fisheye image 201.

Subsequently, the transmission image data generating unit 123, sequentially in the line sequence and in a left-to-right direction, concatenates the remaining portion 300b of the lines resulting from the first division, such that the horizontal path is within the sum of the effective pixel count of the fisheye image 201 and the pixel count of the horizontal blanking interval 203, and the vertical path is within the line count of the vertical blanking interval 202 of the fisheye image data 200. Thus, a second converted image 1200b of a size that can be accommodated within the combined area of the vertical blanking interval 202 and the horizontal blanking interval 203 within the vertical blanking interval 202 is formed.

In the second converted image 1200b depicted in FIG. 12, a (K+1)-th line to an N-th line (where, N is a natural number) are arranged such that the first row is equivalent to the effective pixel count of the fisheye image 201+the horizontal pixel count of the distortion corrected image 300/M. In the second row and thereafter, an (N+1)-th line to the last line are arranged such that each row is of a length equivalent to that of the first row. The line count of the second converted image 1200b/N is less than the line count of the vertical blanking interval 202 of the fisheye image data 200. The above process corresponds to step S706 in the flowchart depicted in FIG. 7.

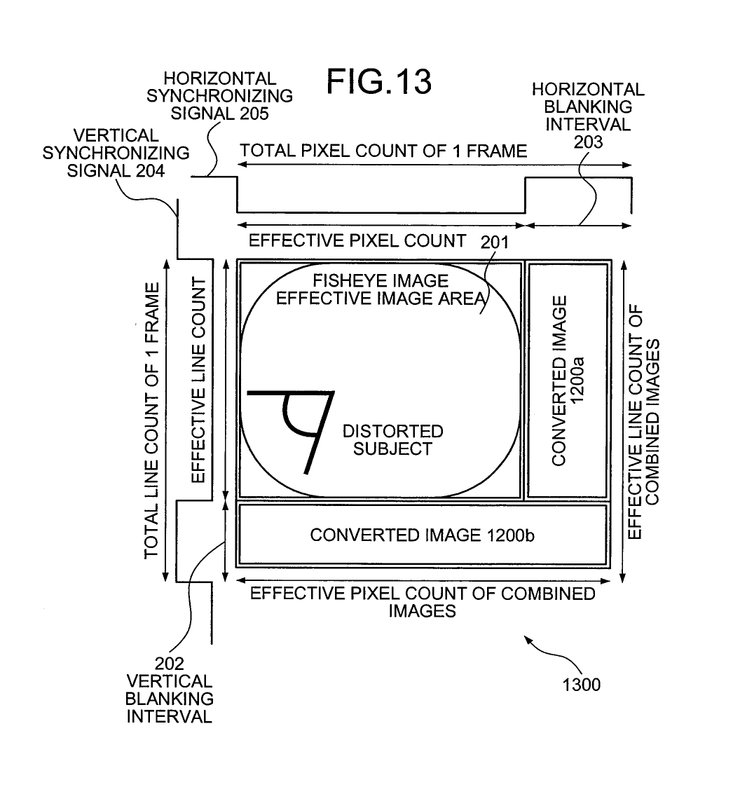

FIG. 13 is a diagram depicting an example of transmission image data 1300 generated by the transmission image data generating unit 123. The transmission image data generating unit 123 inserts the first converted image 1200a into the horizontal blanking interval 203 of the fisheye image data 200 and further inserts the second converted image 1200b into the vertical blanking interval 202 and the horizontal blanking interval 203 within the vertical blanking interval 202, thereby generating the transmission image data 1300. Since the first converted image 1200a and the second converted image 1200b can be accommodated in the vertical blanking interval 202 and the horizontal blanking interval 203, even of the transmission image data 1300 includes the fisheye image 201 as well as the first converted image 1200a and the second converted image 1200b, the data volume does not become large. The above process corresponds to step S707 in the flowchart depicted in FIG. 7.

Processing of the image data receiving device 130 will be described. The image restoration processing unit 132 extracts the first converted image 1200a and the second converted image 1200b from the transmission image data 1300 input via the input port 131 and further restores the first converted image 1200a and the second converted image 1200b.

The first converted image 1200a is formed by following the generation process of the portion 300a of the distortion corrected image 300 in reverse order. In other words, the transmission image data generating unit 123 separates the lines that are connected in the first converted image 1200a. Here, the first to the K-th lines are returned to the state after the second division, i.e., each line is separated from each other, but are respectively in a state of being divided into M segments. Subsequently, the lines, which are respectively divided into M segments, are returned to the state after the first division, i.e., the segments are concatenated according to line, whereby each line occupies a single row. Finally, by arranging the lines in a direction orthogonal to the scanning line used as a reference when the lines are divided in the line sequence at the first division, each line is returned to its original position, enabling the portion 300a of the distortion corrected image 300 to be restored.

The image restoration processing unit 132 follows the generation process of the second converted image 1200b in reverse order and forms the remaining portion 300b of the distortion corrected image 300. In the second converted image 1200b, the remaining portion 300b (the (K+1)-th line to the last line) of the lines into which the distortion corrected image 300 is divided are arranged in the line sequence, in a left-to-right direction. Therefore, after the lines are separated, the lines are arranged in a direction orthogonal to the scanning line used as a reference when the first division is performed according to the line sequence, whereby each of the lines is returned to its original position, enabling the remaining portion 300b of the distortion corrected image 300 to be restored.

Next, the image restoration processing unit 132 integrates the restored portion 300a and the restored remaining portion 300b of the distortion corrected image 300, and restores the distortion corrected image 300. The above process corresponds to step S804 in the flowchart depicted in FIG. 8.

As described, the image data transmitting system of the third embodiment can also achieve effects identical to each of the embodiments above by inserting into the vertical blanking interval 202 and the horizontal blanking interval 203 respectively in which no effective video signal of the fisheye image data 200 is present, the first converted image 1200a and the second converted image 1200b obtained by dividing and re-arranging the distortion corrected image 300 of the fisheye image 201, and by transmitting the resulting image data. In particular, the third embodiment is effective when the information volume of the distortion corrected image 300 is great.

A fourth embodiment of the present invention will be described. The present embodiment is a modification example of the third embodiment. Similar to the third embodiment, the distortion corrected image 300 is converted and inserted into the horizontal blanking interval 203 and the vertical blanking interval 202 of the fisheye image data 200, however, in the fourth embodiment, the vertical blanking interval 202 is located above the fisheye image 201. The technique of the present embodiment is effective when the volume of converted image cannot be accommodated by the horizontal blanking interval 203 alone. The overall configuration of the system is identical to that of the first embodiment. Hereinafter, only processes differing from the third embodiment will be described.

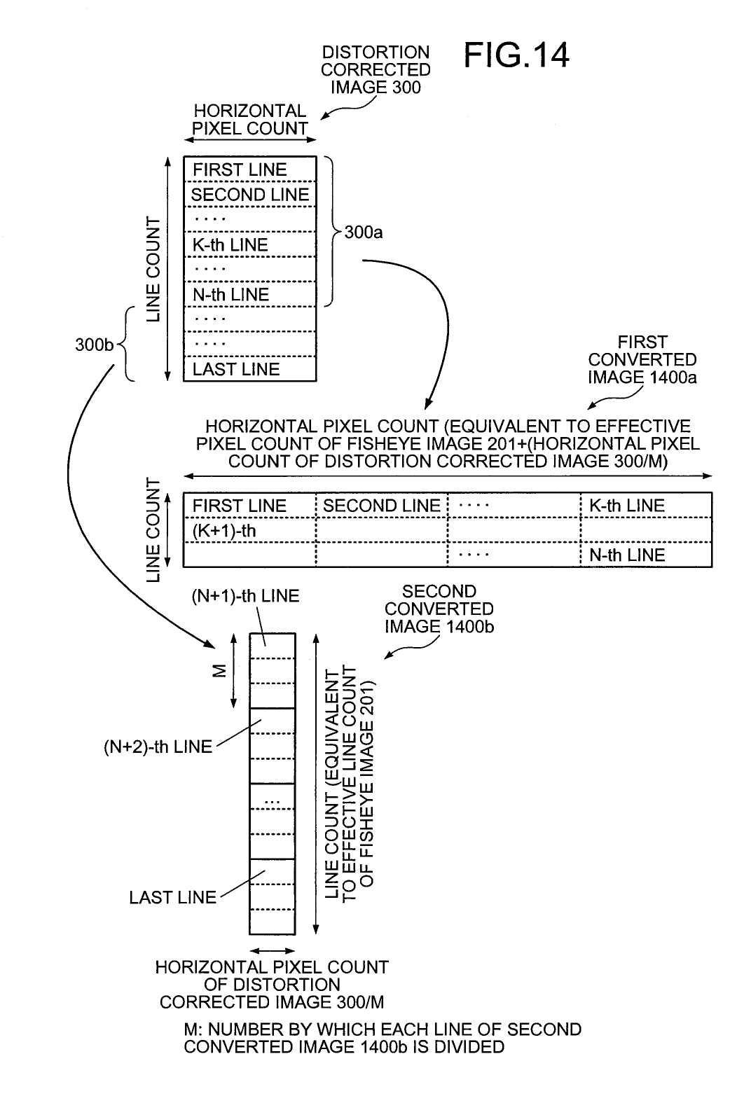

Processing of the image data transmitting device 120 will be described. FIG. 14 is a diagram for describing the conversion process of the distortion corrected image 300 performed by the transmission image data generating unit 123.

As depicted in FIG. 14, the transmission image data generating unit 123 divides the distortion corrected image 300 of one frame, according to line, along the scanning line (first division). The transmission image data generating unit 123 arranges in the line sequence and in a left-to-right direction, a portion 300a of the lines resulting from the first division, such that the horizontal path is within the sum of the effective pixel count of the fisheye image 201 and the pixel count of the horizontal blanking interval 203, and the vertical path is of a maximal length that does not exceed the line count of the vertical blanking interval 202 of the fisheye image data 200. Thus, a first converted image 1400a of a size that can be accommodated within the combined area of the vertical blanking interval 202 and the horizontal blanking interval 203 within the vertical blanking interval 202 is formed.

In the first converted image 1400a depicted in FIG. 14, the first line to a K-th line (where, K is a natural number) are arranged such that the first row is equivalent to the effective pixel count of the fisheye image 201+the horizontal pixel count of the distortion corrected image 300/M. In the second row and thereafter, a (K+1)-th line to an N-th line (where, N is a natural number) are arranged, such that each row is of a length equivalent to that of the first row. The line count of the first converted image 1400a/N is less than the line count of the vertical blanking interval 202 of the fisheye image data 200.

The transmission image data generating unit 123 further divides the remaining portion 300b of the lines obtained from the first division, into segments of a length that is within the pixel count of the horizontal blanking interval 203 of the fisheye image data 200 (second division). The transmission image data generating unit 123, in the line sequence and progressing in a downward direction, arranges the lines subject to the second division, to be within the effective line count of the fisheye image 201. Thus, a second converted image 1400b of a size that can be accommodated within the capacity of the horizontal blanking interval 203 is formed.

In the second converted image 1400b depicted in FIG. 14, similar to the second embodiment, an (N+1)-th line that has been divided into M segments (where, M is a natural number) is positioned at the uppermost position, followed sequentially by an (N+2)-th line, . . . , and the last line, each respectively divided into M segments. The horizontal pixel count (the horizontal path length) of the second converted image 1400b is equivalent to the horizontal pixel count of the distortion corrected image 300/M; and the line count (the vertical path length) of the second converted image 1400b is equivalent to the effective line count of the fisheye image 201. The above process corresponds to step S706 in the flowchart depicted in FIG. 7.

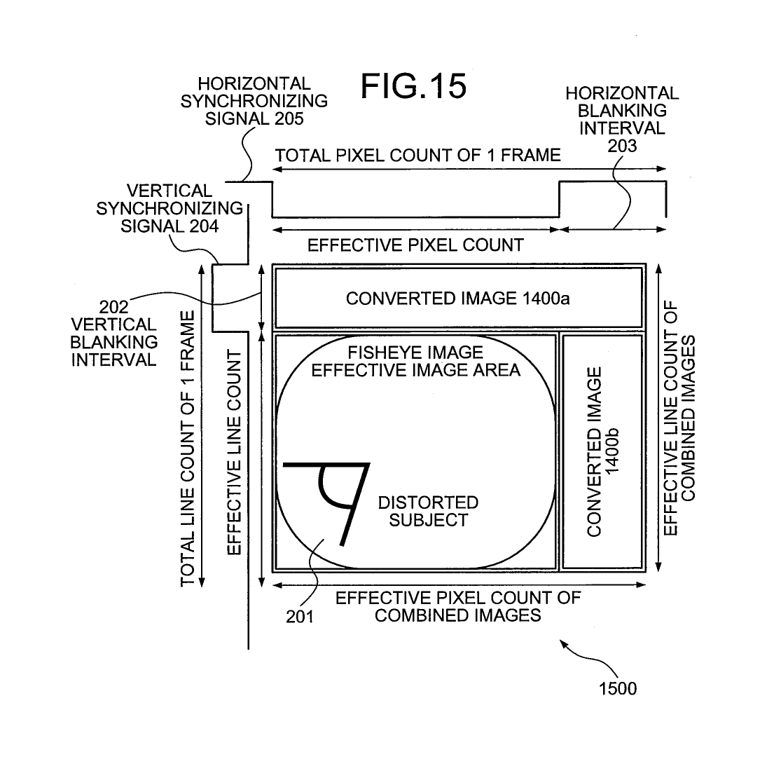

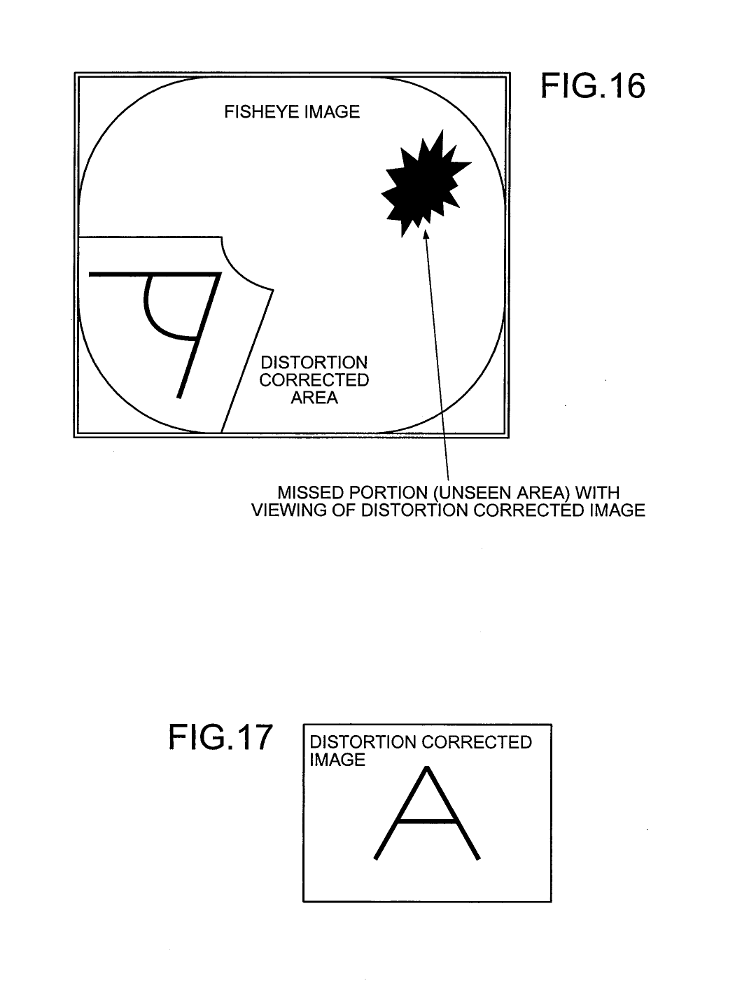

FIG. 15 is a diagram depicting an example of transmission image data 1500 generated by the transmission image data generating unit 123. The transmission image data generating unit 123 inserts the first converted image 1400a into the vertical blanking interval 202 and the horizontal blanking interval 203 within the vertical blanking interval 202 of the fisheye image data 200 and further inserts the second converted image 1400b into the horizontal blanking interval 203 of the fisheye image data 200, thereby generating the transmission image data 1500. Since the first converted image 1400a and the second converted image 1400b can be accommodated in the horizontal blanking interval 203 and the vertical blanking interval 202, even if the transmission image data 1500 includes the fisheye image 201 as well as the first converted image 1400a and the second converted image 1400b, the data volume does not become large. The above process corresponds to step S707 in the flowchart depicted in FIG. 7.

Processing of the image data receiving device 130 will be described. The image restoration processing unit 132 extracts the first converted image 1400a and the second converted image 1400b from the transmission image data 1500 input via the input port 131 and further restores the first converted image 1400a and the second converted image 1400b.

The image restoration processing unit 132 forms the portion 300a of the distortion corrected image 300 by following the generation process of the first converted image 1400a in reverse order. In the first converted image 1400a, the portion 300a (the first line to the N-th line) of the lines into which the distortion corrected image 300 is divided are arranged in the line sequence, in a left-to-right direction. Therefore, by separating the lines from each other and arranging the lines in a direction orthogonal to the scanning line used as a reference when the first division is performed according to the line sequence, each line is returned to its original position, enabling the portion 300a of the distortion corrected image 300 to be restored.

Next, the image restoration processing unit 132 forms the remaining portion 300b of the distortion corrected image 300 by following the generation process of the second converted image 1400b in reverse order. The image restoration processing unit 132 separates the lines that are connected in the second converted image 1400b. Here, each line is returned to the state consequent to the second division, i.e., the (N+1)-th line to the last line are separated from each, but are respectively divided into M segments. Subsequently, the lines, which are respectively divided into M segments, are returned to the state after the first division, i.e., the segments are concatenated according to line, whereby each line occupies a single row. Finally, by arranging the lines in a direction orthogonal to the scanning line used as a reference when the lines are divided in the line sequence at the first division, each line is returned to its original position, enabling the remaining portion 300b of the distortion corrected image 300 to be restored.

Next, the image restoration processing unit 132 integrates the restored portion 300a and the restored remaining portion 300b of the distortion corrected image 300, and restores the distortion corrected image 300. The above process corresponds to step S804 in the flowchart depicted in FIG. 8.

As described, the image data transmitting system of the fourth embodiment can also achieve effects identical to each of the embodiments above by inserting into the horizontal blanking interval 203 and the vertical blanking interval 202 respectively in which no effective video signal of the fisheye image data 200 is present, the first converted image 1400a and the second converted image 1400b obtained by dividing and re-arranging the distortion corrected image 300 of the fisheye image 201, and by transmitting the resulting data. The present embodiment is also effective when the information volume of the distortion corrected image 300 is great.

The image data transmitting method and the image data receiving method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

As described, the present invention is useful for efficiently transmitting information of different types and is particularly effective when image information of various types is desired to be acquired.

The present invention enables image data that includes various types of image information that has a tendency of become a large volume, to be efficiently transmitted and received, without drops in transfer rate.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2012-116968 filed in Japan on May 22, 2012.

What is claimed is:

1. An image data transmitting device that inputs and outputs to an external device, fisheye image data that includes a fisheye image captured by a lens that causes distortion to occur in an image at a wide angle view, the image data transmitting device comprising:
a distortion correction processing unit that corrects the distortion of the fisheye image and forms a distortion corrected image; and
a transmission image data generating unit divides along a scanning line, the distortion corrected image into a plurality of lines, re-arranges the lines based on a given criterion, forms a converted image, inserts the converted imaged into an area in which no effective video signal of the fisheye image data is present, and generates transmission image data.

2. The image data transmitting device according to claim 1, wherein
the transmission image data generating unit divides along the scanning line and according to line, the distortion corrected image; sequentially from a first line, sequentially arranges the lines in a single direction of the lines, such that a horizontal path is within a sum of an effective pixel count of the fisheye image and a pixel count of a horizontal blanking interval, and a vertical path is within a line count of a vertical blanking interval of the fisheye image data to form the converted image; inserts the converted image into the vertical blanking interval of the fisheye image data; and generates the transmission image data.

3. The image data transmitting device according to claim 1, wherein
the transmission image data generating unit divides along the scanning line and according to line, the distortion corrected image; sequentially from a first line, arranges the lines in a single direction of the lines, such that a horizontal path is equivalent to an effective pixel count of the fisheye image, and a vertical path is within a line count of a vertical blanking interval of the fisheye image data to form the converted image; inserts the converted image into the vertical blanking interval of the fisheye image data; and generates transmission image data.

4. The image data transmitting device according to claim 1, wherein
the transmission image data generating unit performs a first division of dividing along the scanning line and according to line, the distortion corrected image; performs a second division of dividing the lines obtained from the first division, into segments of a length that is within a pixel count of a horizontal blanking interval of the fisheye image data; sequentially from a first line and progressing downward, arranges the segments obtained from the second division, to be within a sum of an effective line count of the fisheye image and a line count of a vertical blanking interval to form the converted image; inserts the converted image into the horizontal blanking interval of the fisheye image data; and generates transmission image data.

5. The image data transmitting device according to claim 1, wherein
the transmission image data generating unit performs a first division of dividing the distortion corrected image according to line, along the scanning line; performs a second division of dividing the lines obtained from the first division, into segments of a length that is within a pixel count of a horizontal blanking interval of the fisheye image data; sequentially from a first line and progressing downward, arranges the segments obtained from the second division, to be within an effective line count of the fisheye image to form the converted image; inserts the converted image into the horizontal blanking interval of the fisheye image data; and generates transmission image data.

6. The image data transmitting device according to claim 1, wherein
the transmission image data generating unit performs a first division of dividing the distortion corrected image, according to line, along the scanning line; performs a second division of dividing a portion of the lines obtained from the first division, into segments of a length that is within a pixel count of a horizontal blanking interval of the fisheye image data; sequentially from a first line and progressing downward, arranges the portion of the lines subject to the second division, to be within an effective line count of the fisheye image to form a first converted image; sequentially in a line sequence and in a single direction of the lines, arranges a remaining portion of the lines obtained from the first division, such that a horizontal path is within a sum of an effective pixel count of the fisheye image and a pixel count of the horizontal blanking interval, and a vertical path is within a line count of a vertical blanking interval of the fisheye image data to form a second converted image; inserts the first converted image into the horizontal blanking interval of the fisheye image data and inserts the second converted image into the vertical blanking interval and a horizontal blanking interval within the vertical blanking interval; and generates transmission image data.

7. The image data transmitting device according to claim 1, wherein
the transmission image data generating unit performs a first division of dividing the distortion corrected image according to line, along the scanning line; sequentially from a first line and in a single direction of the lines, arranges a portion of the lines obtained from the first division, such that a horizontal path is within a sum of an effective pixel count of the fisheye image and a pixel count of a horizontal blanking interval of the fisheye image data, and a vertical path is of a maximal length that does not exceed a line count of a vertical blanking interval of the fisheye image data to form a first converted image; performs a second division of dividing a remaining portion of the lines obtained from the first division, into segments of a length that is within the pixel count of the horizontal blanking interval; sequentially from a first line and progressing downward, arranges the lines subject to the second division, to be within an effective line count of the fisheye image to form a second converted image; inserts the first converted image into the vertical blanking interval of the fisheye image data and a horizontal blanking interval within the vertical blanking interval and inserts the second converted image into the horizontal blanking interval; and generates transmission image data.

8. An image data receiving device receiving the transmission image data output from the image data transmitting device according to claim 1, the image data receiving device comprising:
an image restoration processing unit that extracts the converted image from the transmission image data, divides the converted image into the respective lines arranged based on the given criterion, and re-arranges the lines into the line sequence to restore the distortion corrected image; and
an image displaying unit that displays at least any one among the distortion corrected image and the fisheye image.

9. An image data transmitting system comprising:
a camera having a function of generating the fisheye image data that includes the fisheye image captured by the lens that causes distortion to occur at a wide angle view;
the image data transmitting device according to claim 1; and
an image data receiving device receiving the transmission image data output from the image data transmitting device, the image data receiving device comprising:
an image restoration processing unit that extracts the converted image from the transmission image data, divides the converted image into the respective lines arranged based on the given criterion, and re-arranges the lines into the line sequence to restore the distortion corrected image; and
an image displaying unit that displays at least any one among the distortion corrected image and the fisheye image.

10. Transmission image data generated by inserting a converted image formed by changing a distortion corrected image of a fisheye image based on a given criterion, into at least any one among a horizontal blanking interval and a vertical blanking interval that are respectively areas in which no effective video signal of image data that includes the fisheye image.

11. An image data transmitting method executed by an image data transmitting device that inputs and outputs to an external device, fisheye image data that includes an fisheye image captured by a lens that causes distortion to occur in an image at a wide angle, the image data transmitting method comprising:
correcting the distortion of the fisheye image and forming a distortion corrected image; and
dividing along a scanning line, the distortion corrected image into a plurality of lines, re-arranging the lines based on a given criterion and forming a converted image, inserting the converted image into an area in which no effective video signal of the fisheye image data is present, and thereby generating transmission image data.

12. The image data transmitting method according to claim 11, wherein
the generating the transmission image includes:
dividing along the scanning line and according to line, the distortion corrected image,
sequentially from a first line, arranging the lines in a single direction of the lines, such that a horizontal path is within a sum of an effective pixel count of the fisheye image and a pixel count of the a horizontal blanking interval, and a vertical path is within a line count of a vertical blanking interval of the fisheye image data, and
inserting the converted image into the vertical blanking interval.

13. The image data transmitting method according to claim 11, wherein
the generating the transmission image includes:
dividing along the scanning line and according to line, the distortion corrected image,
sequentially from a first line, arranging the lines in a single direction of the lines, such that a horizontal path is equivalent to an effective pixel count of the fisheye image, and a vertical path is within a line count of a vertical blanking interval of the fisheye image data, and
inserting the converted image into the vertical blanking interval.

14. The image data transmitting method according to claim 11, wherein
the generating the transmission image includes:
performing a first division of dividing along the scanning line and according to line, the distortion corrected image,
performing a second division of dividing the lines obtained from the first division, into segments of a length that is within a pixel count of a horizontal blanking interval of the fisheye image data,
sequentially from a first line and progressing downward, arranging the segments obtained from the second division, to be within a sum of an effective line count of the fisheye image and a line count of a vertical blanking interval, and
inserting the converted image into the horizontal blanking interval of the fisheye image data.

15. The image data transmitting method according to claim 11, wherein
the generating the transmission image includes:
performing a first division of dividing along the scanning line and according to line, the distortion corrected image,
performing a second division of dividing the lines obtained from the first division, into segments of a length that is within a pixel count of a horizontal blanking interval of the fisheye image data,
sequentially from a first line and progressing downward, arranging the segments obtained from the second division, to be within an effective line count of the fisheye image, and
inserting the converted image into the horizontal blanking interval of the fisheye image data.

16. The image data transmitting method according to claim 11, wherein
the generating the transmission image includes:
performing a first division of dividing along the scanning line and according to line, the distortion corrected image,
performing a second division of dividing a portion of the lines obtained from the first division, into segments of a length that is within a pixel count of a horizontal blanking interval of the fisheye image data,
forming a first converted image by sequentially from a first line and progressing downward, arranging the portion of the lines subject to the second division, to be within an effective line count of the fisheye image,
forming a second converted image by sequentially in a line sequence and in a single direction of the lines, arranging a remaining portion of the lines obtained at the first division, such that a horizontal path is within a sum of an effective pixel count of the fisheye image and a pixel count of the horizontal blanking interval, and a vertical path is within a line count of a vertical blanking interval of the fisheye image data, and
inserting the first converted image into the horizontal blanking interval of the fisheye image data and inserting the second converted image into the vertical blanking interval and a horizontal blanking interval within the vertical blanking interval.

17. The image data transmitting method according to claim 11, wherein
the generating the transmission image includes:
forming a first converted image by
performing a first division of dividing along the scanning line and according to line, the distortion corrected image, and
sequentially from a first line and in a single direction of the lines, arranging a portion of the lines obtained from the first division, such that a horizontal path is within a sum of an effective pixel count of the fisheye image and a pixel count of a horizontal blanking interval of the fisheye image data, and a vertical path is of a maximal length that does not exceed a line count of a vertical blanking interval of the fisheye image data,
forming a second converted image by
performing a second division of dividing a remaining portion of the lines obtained from the first division, into segments of a length that is within the pixel count of the horizontal blanking interval, and
sequentially from a first line and progressing downward, arranging the lines subject to the second division, to be within an effective line count of the fisheye image,
inserting the first converted image into the vertical blanking interval of the fisheye image data and a horizontal blanking interval within the vertical blanking interval, and
inserting the second converted image into the horizontal blanking interval.

18. An image data receiving method of receiving the transmission image data generated by the image data transmitting method according to claim 11, the image data receiving method comprising:
extracting the converted image from the transmission image data, dividing the converted image into the respective lines arranged based on the given criteria, and re-arranging the lines into the line sequence to restore the distortion corrected image; and
displaying at least any one among the distortion corrected image and fisheye image.

19. A computer-readable recording medium storing a program that causes a computer to execute the image data transmitting method according to claim 11.

20. A computer-readable recording medium storing a program that causes a computer to execute the image data receiving method according to claim 18.
